(19) United States
(12) Patent Application Publication
(10) Pub. No.: US 2025/0208466 A1
(43) Pub. Date: Jun. 26, 2025

(54) LIGHT COLLIMATING FILM FOR LIQUID CRYSTAL DISPLAY BACKLIGHT

(71) Applicant: Meta Platforms Technologies, LLC, Menlo Park, CA (US)

(72) Inventors: Xinyu ZHU, San Jose, CA (US); Yu-Jen WANG, San Jose, CA (US); Shenglin YE, Santa Clara, CA (US); Liliana Ruiz DIAZ, Bothell, WA (US); Linghui RAO, Redmond, WA (US)

(21) Appl. No.: 18/979,216

(22) Filed: Dec. 12, 2024

Related U.S. Application Data
(60) Provisional application No. 63/613,006, filed on Dec. 20, 2023.

(51) Int. Cl. G02F 1/1335; G02B 27/01; G02B 27/30; G02F 1/13357

(52) U.S. Cl. CPC G02F 1/133607; G02B 27/0172; G02B 27/30; G02F 1/133514; G02F 1/133536; G02F 1/133603; G02F 1/133615; G02F 1/13362; G02B 2027/0178

(57) ABSTRACT

A liquid crystal display panel for near-eye display comprises a liquid crystal (LC) panel, a backlight unit, and a light collimating film that is a part of the LC panel, a part of the backlight unit, or between the LC panel and the backlight unit. The light collimating film is configured to transmit on-axis light and at least partially reflect off-axis light. In one example, the light collimating film includes a plurality of isotropic layers interleaved with a plurality of positive and/or negative C-plate layers.

### CROSS-REFERENCE TO RELATED APPLICATIONS

This application claims the benefit of and priority to U.S. Provisional Application No. 63/613,006, filed Dec. 20, 2023, entitled “LIGHT COLLIMATING FILM FOR LIQUID CRYSTAL DISPLAY BACKLIGHT,” which is hereby incorporated by reference in its entirety.

### BACKGROUND

An artificial reality system, such as a head-mounted display (HMD) or heads-up display (HUD) system, generally includes a near-eye display system in the form of a headset or a pair of glasses and configured to present content to a user via an electronic or optic display within, for example, about 10-20 mm in front of the user's eyes. The near-eye display system may display virtual objects or combine images of real objects with virtual objects, as in virtual reality (VR), augmented reality (AR), or mixed reality (MR) applications. A near-eye display generally includes an optical system configured to form an image of a computer-generated image on an image plane. The optical system of the near-eye display may relay the image generated by an image source (e.g., a display panel) to create a virtual image that appears to be away from the image source and further than just a few centimeters away from the user's eyes.

### SUMMARY

This disclosure relates generally to liquid crystal display (LCD). More specifically, and without limitation, techniques disclosed herein relate to improving the angular beam profiles of backlight units (BLUs) of LCD panels used in near-eye display, thereby improving the efficiency of the near-eye display that may include viewing optics with a limited angular acceptance range. Various inventive embodiments are described herein, including devices, systems, methods, structures, materials, processes, and the like.

According to certain embodiments, a liquid crystal display may include a liquid crystal (LC) panel, a backlight unit, and a light collimating film that is a part of the LC panel, a part of the backlight unit, or between the LC panel and the backlight unit, where the light collimating film is configured to transmit on-axis light and at least partially reflect off-axis light. The backlight unit may include, for example, an edge-lit backlight unit or a two-dimensional array of mini- or micro-LEDs.

In some embodiments, the light collimating film may include a plurality of isotropic layers interleaved with a plurality of C-plate layers. Each of the plurality of C-plate layers may include a uniaxial birefringent material with an optical axis in a surface normal direction of the LC panel. An optical thickness of a layer of the plurality of isotropic layers and the plurality of C-plate layers may be equal to about a quarter of a wavelength of visible light. In some embodiments, an optical thickness of a first layer of the plurality of isotropic layers and the plurality of C-plate layers may be equal to about a quarter of a first wavelength of visible light, and an optical thickness of a second layer of the plurality of isotropic layers and the plurality of C-plate layers may be equal to a quarter of a second wavelength of visible light. In some embodiments, optical thicknesses of the plurality of isotropic layers and the plurality of C-plate layers may vary gradually. The C-plate layers may include +C-plate layers, −C-plate layers, or a combination thereof. In some embodiments, the light collimating film may include more than 100 layers.

In some embodiments, the light collimating film may be between a rear polarizer of the LC panel and a reflective polarizer, or may be between a reflective polarizer and the backlight unit. In some embodiments, the light collimating film may be integrated onto a same substrate with a rear polarizer of the LC panel, a reflective polarizer, or both the rear polarizer and the reflective polarizer. The reflective polarizer may be configured to transmit light in a first polarization state and reflect light in an orthogonal polarization state, or transmit light with polarization directions parallel to a vertical plane. In some embodiments, the backlight unit may include a prism layer including a one-dimensional array of prisms arranged along a horizontal direction, and apex angles of the prisms may be selected to reduce a full-width-half-maximum (FWHM) angular range of a luminance profile of the backlight unit in a horizontal plane.

According to certain embodiments, a near-eye display may include the liquid crystal display described herein, and viewing optics configured to project images displayed by the liquid crystal display to a user's eye.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 is a cross-sectional view of an example of a near-eye display according to certain embodiments.

FIG. 5 illustrates an example of an optical system with a non-pupil forming configuration for a near-eye display device according to certain embodiments.

FIG. 6 illustrates an example of a liquid crystal display (LCD) panel.

FIG. 7 illustrates an example of a layer stack of an LCD panel.

FIG. 8A illustrates an example of a backlight unit (BLU) in an LCD panel.

FIG. 8B illustrates an example of a brightness enhance film in the backlight unit of FIG. 8A.

FIG. 9A illustrates an example of a backlight unit of an LCD panel that has a large view angle range.

FIG. 9B illustrates an example of an edge-lit backlight unit of an LCD panel of a near-eye display device.

FIG. 9C illustrates an example of a backlight unit including a two-dimensional arrays of mini-LEDs in an LCD panel of a near-eye display device.

FIG. 10A illustrates angular luminance profiles of an example of an edge-lit backlight unit in an LCD panel of a near-eye display device.

FIG. 10B illustrates angular luminance profiles of an example of a backlight unit including a two-dimensional arrays of mini-LEDs in an LCD panel of a near-eye display device.

FIG. 11 illustrates an example of a near-eye display that includes a display panel and display optics.

FIG. 12A illustrates an example of an edge-lit backlight unit including a light collimating film in an LCD panel of a near-eye display device according to certain embodiments.

FIG. 12B illustrates an example of a backlight unit including a two-dimensional array of mini-LEDs and a light collimating film in an LCD panel of a near-eye display device according to certain embodiments.

FIG. 13 illustrates an example of a light collimating film of a backlight unit in an LCD panel of a near-eye display device according to certain embodiments.

FIG. 14A illustrates an example of a structure including a reflective polarizer and a light collimating film for controlling the angular luminance profile and improving the light efficiency of a backlight unit in an LCD panel of a near-eye display device according to certain embodiments.

FIG. 14B illustrates an example of an index ellipsoid showing the refractive index of a light beam propagating in a uniaxial birefringent material.

FIG. 15A illustrates an example of a light collimating film including +C-plate layers according to certain embodiments.

FIG. 15B illustrates examples of parameters of the light collimating film of FIG. 15A according to certain embodiments.

FIGS. 15C-15F illustrate simulation results of examples of the light collimating film of FIG. 15A for controlling angular luminance profiles according to certain embodiments.

FIG. 16A illustrates an example of a light collimating film including −C-plate layers according to certain embodiments.

FIG. 16B illustrates examples of parameters of the light collimating film of FIG. 16A according to certain embodiments.

FIGS. 16C and 16D illustrate simulation results of examples of the light collimating film of FIG. 16A for controlling angular luminance profiles according to certain embodiments.

FIG. 17A illustrates an example of a prism layer for brightness enhancement in a backlight unit.

FIG. 17B illustrates examples of angular luminance profiles of an example of a backlight unit.

FIG. 18 illustrates an example of an electronic system of an example of a near-eye display for implementing some of the examples disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to liquid crystal display (LCD). More specifically, and without limitation, techniques disclosed herein relate to improving the angular beam profiles of backlight units (BLUs) of LCD panels used in near-eye display, thereby improving the efficiency of the near-eye display that may include viewing optics with a limited angular acceptance range. Various inventive embodiments are described herein, including devices, systems, methods, structures, materials, processes, and the like.

In near-eye displays, the display panels or image sources may be implemented using, for example, a liquid crystal display (LCD), an organic light emitting diode (OLED) display, a micro-OLED display, an inorganic light emitting diode (ILED) display, a quantum-dot light emitting diode (QLED) display, a micro-light emitting diode (micro-LED) display, an active-matrix OLED display (AMOLED), a transparent OLED display (TOLED), or some other displays. It is generally desirable that the image source or the display panel of a near-eye display system has a higher resolution, a higher brightness, a large color gamut, and a large size, such that the near-eye display system may have a large field of view (FOV) and better image quality to, for example, improve the immersive experience of using the near-eye display system. For a battery-powered near-eye display system, it may also be desirable that the system has a higher efficiency to improve the battery life of the system.

An LCD panel may include a backlight unit (BLU) and a liquid crystal (LC) panel that may modulate and filter light from the BLU at individual pixels. The LC panel may include a liquid crystal cell sandwiched by a bottom substrate and a top substrate. In some implementations, the bottom substrate may include thin-film transistor (TFT) circuits formed on a glass substrate for controlling the liquid crystal cell, whereas the top substrate may include a common electrode and an array of color filters formed on another glass substrate. In some implementations, the bottom substrate may include both TFT circuits and an array of color filters formed on a glass substrate (referred to as color filter on array (COA)), whereas the top substrate may include a common electrode and a black matrix formed on another glass substrate. In some implementations, pixel electrodes and the common electrode may both be formed on the bottom substrate, for example, in fringe field switching (FFS) mode liquid crystal display, whereas the top substrate may include a black matrix and an overcoat layer formed on another glass substrate.

LCD panels may offer some advantages over other display technologies, such as lower cost, longer lifetime, higher energy efficiencies, larger sizes, and the like. However, high-resolution LC panels (e.g., with a pixel per inch (PPI) greater than about 600 or higher such as 1400 or higher) may have low panel transmission. Therefore, it may be desirable to improve the efficiency of the BLU to improve the overall efficiency and brightness of the LCD panel. Many techniques can be utilized to improve the efficiency of BLU, such as prism-based brightness enhancement films (BEFs) that can manage the angular output of the light from BLU and focus light towards on-axis viewers of the display, reflective polarizer-based brightness enhancement films that can reflect polarized light not used by the LC panel to recycle the reflected light, and the like. However, further improvement of the efficiency may still be needed for LCD panels with high resolution.

In display devices that may be far away from the user's eyes, such as TVs, laptops, and smartphones, it may be desirable that the display devices have large ranges of view angles, such that the displayed content may be viewable by users from many different angles. But a near-eye display (e.g., a head-mounted display) may include display panels near the user's eyes, and may include viewing optics (also referred to as display optics) that can project images displayed by the display panels such that the images may appear to be further away from the user's eyes. Due to the size and weight limitation of the near-eye display, the viewing optics may have limited apertures and limited light acceptance angles. As such, light emitted from the display panels at large angles may not be collected by the viewing optics and projected on the eyebox of the near-eye display. Therefore, the portion of the light that is emitted from the display panels at large angles may be wasted. To improve the efficiency of near-eye display devices, it may be desirable that the light emitted from the backlight unit and thus the LCD panel has narrow angular luminance profiles in both the horizontal and vertical planes, such that more emitted light may be collected by the viewing optics.

According to certain embodiments disclosed herein, to improve the efficiency of a near-eye display that uses an LCD panel including a BLU and an LC panel, a light collimating film may be used between the BLU and the LC panel (or as a part of the BLU or LC panel) to modify the angular beam profile of the light from the BLU in at least one plane (e.g., a vertical plane). The light collimating film may reflect off-axis light while allowing on-axis or paraxial light to pass through, such that the light beam emitted from the LCD panel may have a narrower beam profile in at least the vertical plane. The angular luminance profile of the light emitted from the BLU in the horizontal plane may be narrowed using, for example, the prism layers. Therefore, the light beam emitted from the BLU and the LCD panel can have narrow angular luminance profiles in both the horizontal plane and the vertical plane, and thus may be more efficiently collected by the viewing optics to deliver to the user's eye.

In some implementations, the light collimating film may include a plurality of isotropic material layers interleaved with a plurality of C-plate layers that include uniaxial birefringent materials. The refractive index of the C-plate layers for light propagating in the surface normal direction may be similar to the refractive index of the isotropic layers, and thus the light propagating in the surface normal direction may experience minimum or no reflection at the interface between an isotropic layer and a C-plate layer. The refractive index of the C-plate layers for light propagating in directions that are different from the surface normal direction may be different from the refractive index of the isotropic layers, and thus the light propagating in directions that are different from the surface normal direction may be at least partially reflected at the interface between an isotropic layer and a C-plate layer due to Fresnel reflection. The larger the difference between the propagation angle and the surface normal direction, the larger the difference between the refractive index of the isotropic layer and the refractive index of the C-plate layer, and thus the higher the reflection. As such, light with larger emission angles may be reflected with higher reflectivity. Therefore, the light passing through the light collimating film may have a narrower angular luminance profile.

The LCD panels described herein may be used in conjunction with various technologies, such as an artificial reality system. An artificial reality system, such as a head-mounted display (HMD) or heads-up display (HUD) system, generally includes a display configured to present artificial images that depict objects in a virtual environment. The display may present virtual objects or combine images of real objects with virtual objects, as in virtual reality (VR), augmented reality (AR), or mixed reality (MR) applications. For example, in an AR system, a user may view both displayed images of virtual objects (e.g., computer-generated images (CGIs)) and the surrounding environment by, for example, seeing through transparent display glasses or lenses (often referred to as optical see-through) or viewing displayed images of the surrounding environment captured by a camera (often referred to as video see-through).

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

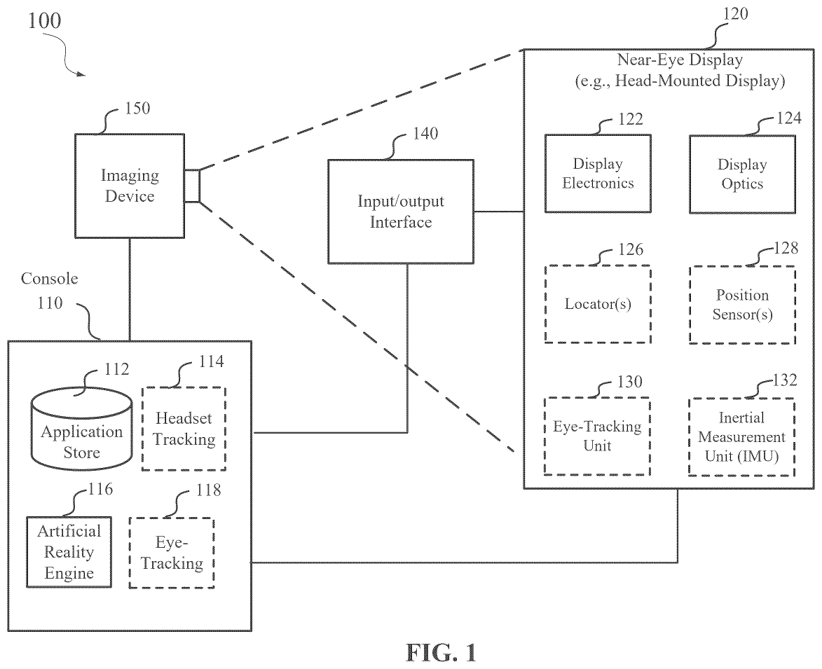

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

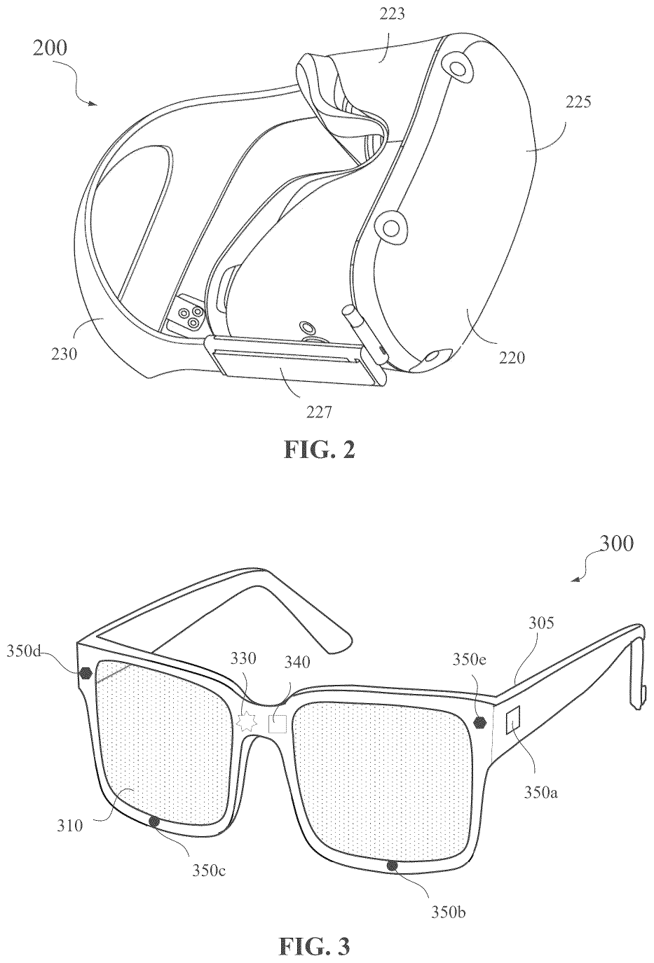

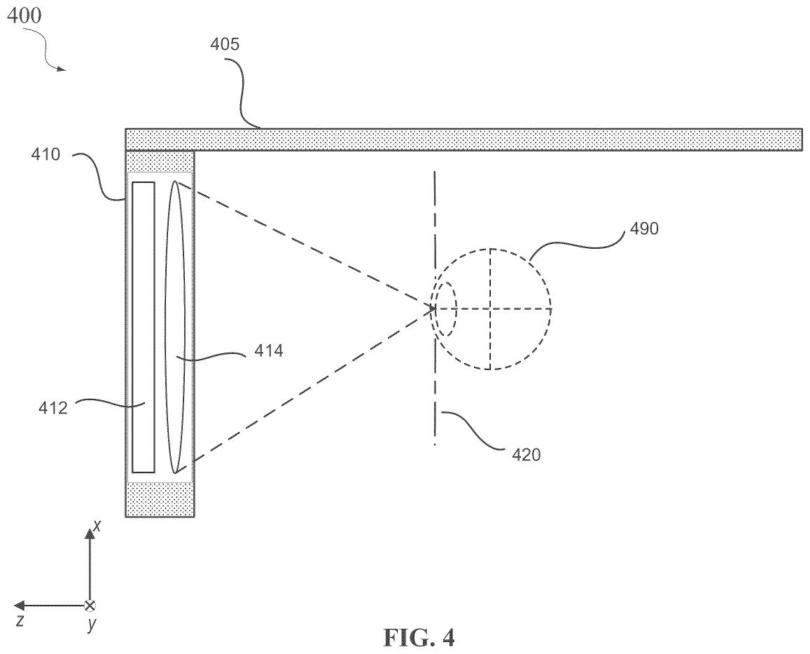

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be a light-emitting diode (LED), a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 12 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 120 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking subsystem 114, an artificial reality engine 116, and an eye-tracking subsystem 118. Some embodiments of console 110 may include different or additional devices or subsystems than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the devices or subsystems of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking subsystem 114 may track movements of near-eye display 120 using slow calibration information from external imaging device 150. For example, headset tracking subsystem 114 may determine positions of a reference point of near-eye display 120 using observed locators from the slow calibration information and a model of near-eye display 120. Headset tracking subsystem 114 may also determine positions of a reference point of near-eye display 120 using position information from the fast calibration information. Additionally, in some embodiments, headset tracking subsystem 114 may use portions of the fast calibration information, the slow calibration information, or any combination thereof, to predict a future location of near-eye display 120. Headset tracking subsystem 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking subsystem 114. Artificial reality engine 116 may also receive estimated eye position and orientation information from eye-tracking subsystem 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking subsystem 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking subsystem 118 to more accurately determine the eye's orientation.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. High-resolution camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

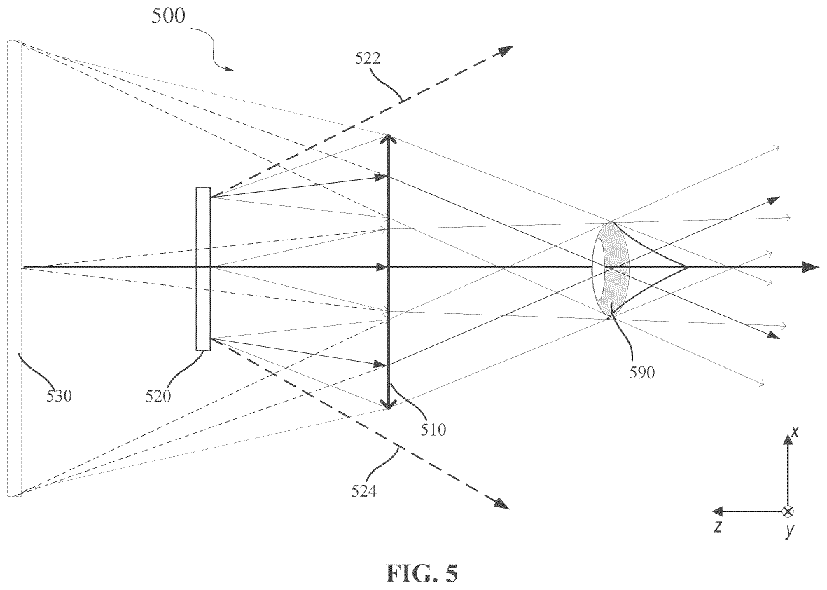

FIG. 4 is a cross-sectional view of an example of a near-eye display 400 according to certain embodiments. Near-eye display 400 may include at least one display assembly 410. Display assembly 410 may be configured to direct image light (e.g., display light) to an eyebox located at an exit pupil 420 and to user's eye 490. It is noted that, even though FIG. 4 and other figures in the present disclosure show an eye of a user of the near-eye display for illustration purposes, the eye of the user is not a part of the corresponding near-eye display.

As HMD device 200 and near-eye display 300, near-eye display 400 may include a frame 405 and display assembly 410 that may include a display 412 and/or display optics 414 coupled to or embedded in frame 405. As described above, display 412 may display images to the user electrically (e.g., using LCDs, LEDs, OLEDs) or optically (e.g., using a waveguide display and optical couplers) according to data received from a processing unit, such as console 110. In some embodiments, display 412 may include a display panel that includes pixels made of LCDs, LEDs, OLEDs, and the like. Display 412 may include sub-pixels to emit light of a predominant color, such as red, green, blue, white, or yellow. In some embodiments, display assembly 410 may include a stack of one or more waveguide displays including, but not restricted to, a stacked waveguide display, a varifocal waveguide display, and the like. The stacked waveguide display may be a polychromatic display (e.g., a red-green-blue (RGB) display) created by stacking waveguide displays whose respective monochromatic sources are of different colors.

Display optics 414 may be similar to display optics 124 and may display image content optically (e.g., using optical waveguides and optical couplers), correct optical errors associated with the image light, combine images of virtual objects and real objects, and present the corrected image light to exit pupil 420 of near-eye display 400, where the user's eye 490 may be located. In some embodiments, display optics 414 may also relay the images to create virtual images that appear to be away from display 412 and further than just a few centimeters away from the eyes of the user. For example, display optics 414 may collimate the image source to create a virtual image that may appear to be far away (e.g., greater than about 0.3 m, such as about 0.5 m, 1 m, or 3 m away) and convert spatial information of the displayed virtual objects into angular information. In some embodiments, display optics 414 may also magnify the source image to make the image appear larger than the actual size of the source image. More details of display 412 and display optics 414 are described below.

In various implementations, the optical system of a near-eye display, such as an HMD, may be pupil-forming or non-pupil-forming. Non-pupil-forming HMDs may not use intermediary optics to relay the displayed image, and thus the user's pupils may serve as the pupils of the HMD. Such non-pupil-forming displays may be variations of a magnifier (sometimes referred to as “simple eyepiece”), which may magnify a displayed image to form a virtual image at a greater distance from the eye. The non-pupil-forming display may use fewer optical elements. Pupil-forming HMDs may use optics similar to, for example, optics of a compound microscope or telescope, and may include some forms of projection optics that magnify an image and relay it to the exit pupil.

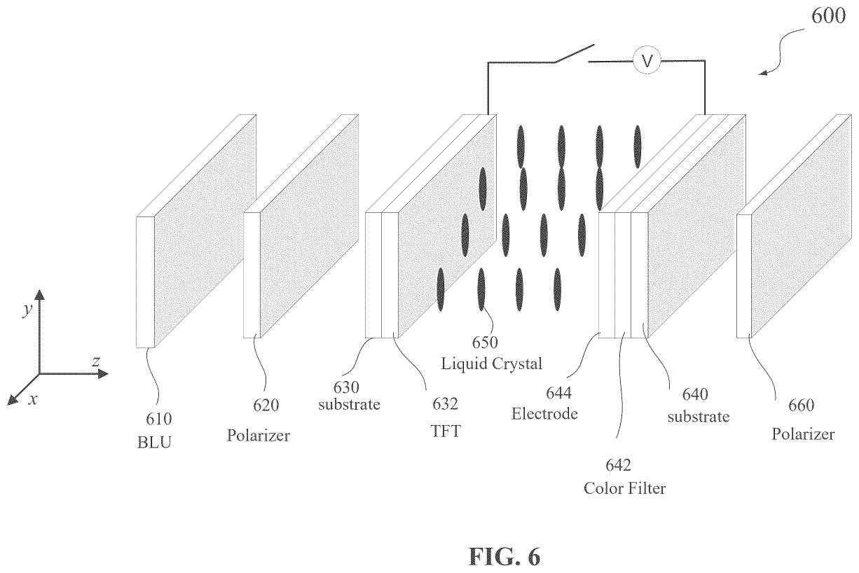

FIG. 5 illustrates an example of an optical system 500 with a non-pupil forming configuration for a near-eye display device according to certain embodiments. Optical system 500 may be an example of near-eye display 400, and may include display optics 510 and an image source 520 (e.g., a display panel). Display optics 510 may function as a magnifier. FIG. 5 shows that image source 520 is in front of display optics 510. In some other embodiments, image source 520 may be located outside of the field of view of the user's eye 590. For example, one or more deflectors or directional couplers may be used to deflect light from an image source to make the image source appear to be at the location of image source 520 shown in FIG. 5. Image source 520 may be an example of display 412 described above. For example, image source 520 may include a two-dimensional array of light emitters, such as semiconductor micro-LEDs or micro-OLEDs. The dimensions and pitches of the light emitters in image source 520 may be small. For example, each light emitter may have a diameter less than 2 μm (e.g., about 1.2 μm) and the pitch may be less than 2 μm (e.g., about 1.5 μm). As such, the number of light emitters in image source 520 can be equal to or greater than the number of pixels in a display image, such as 960×720, 1280×720, 1440×1080, 1920×1080, 2160×1080, 2560×1080, or even more pixels. Thus, a display image may be generated simultaneously by image source 520.

Light from an area (e.g., a pixel or a light emitter) of image source 520 may be directed to a user's eye 590 by display optics 510. Light directed by display optics 510 may form virtual images on an image plane 530. The location of image plane 530 may be determined based on the location of image source 520 and the focal length of display optics 510. A user's eye 590 may form a real image on the retina of user's eye 590 using light directed by display optics 510. In this way, objects at different spatial locations on image source 520 may appear to be objects on an image plane far away from user's eye 590 at different viewing angles. Image source 520 may have a size larger or smaller than the size (e.g., aperture) of display optics 510. Some light emitted from image source 520 with large emission angles (as shown by light rays 522 and 524) may not be collected and directed to user's eye 590 by display optics 510, and may become stray light.

The display panels or image sources described above (e.g., display 412 or image source 520) may be implemented using, for example, a liquid crystal display (LCD), an organic light emitting diode (OLED) display, a micro-OLED display, an inorganic light emitting diode (ILED) display, a micro-light emitting diode (micro-LED) display, an active-matrix OLED display (AMOLED), a transparent OLED display (TOLED), or some other displays. In a near-eye display system, it is generally desirable that the image source or the display panel has a higher resolution and a large size, such that the near-eye display system may have a large field of view (FOV) and better image quality to, for example, improve the immersive experience of using the near-eye display system. The FOV of a display system is the angular range over which an image may be projected in the near or far field. The FOV of a display system is generally measured in degrees, and the resolution over the FOV is generally measured in pixels per degree (PPD). The FOV of a display system may be linearly proportional to the size of the image source (e.g., the display panel), and may be inversely proportional to the focal length of the display optics (e.g., a collimation lens or lens assembly). A balance between the size of the image source and the optical power of the display optics may be needed in order to achieve a good modulation transfer function (MTF) and reduced size/weight/cost. The field of view may be increased by bringing the image source closer, but the image source would need to have higher PPD, and the aberrations of the display optics at the periphery may limit the effective field of view. To achieve a high PPD, micro displays with ultra-high pixels per inch (PPI) may be needed. There may be many technological challenges and cost issues associated with making high-PPI display panels, such as high resolution LCD panels.

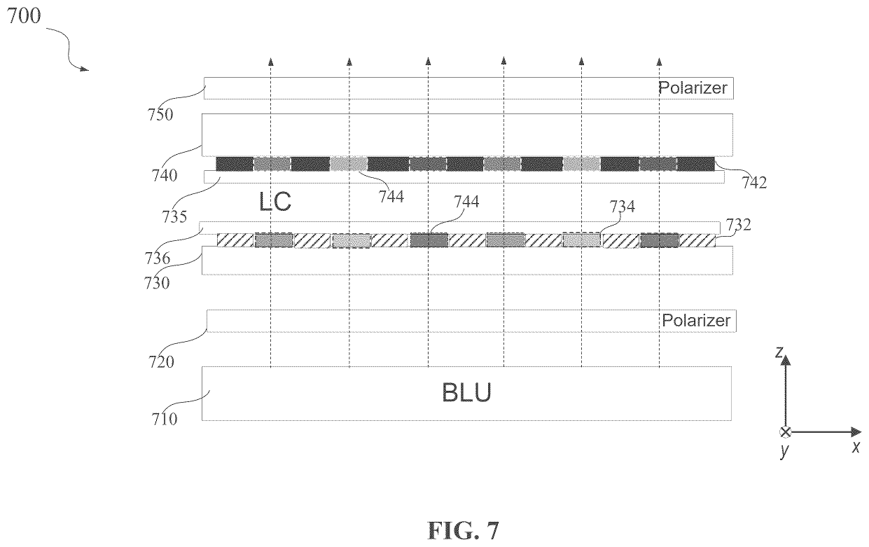

FIG. 6 illustrates an example of an LCD panel 600. As illustrated, LCD panel 600 may include a backlight unit (BLU) 610 configured to emit illumination light, a first polarizer 620 configured to control the type of light that can pass through (e.g., based on the polarization state of the light), an LCD cell that may modulate (e.g., the phase or polarization state of) the incident light, and a second polarizer 660 for control the type of light that can pass through (e.g., based on the polarization state of the light). In some embodiments, BLU 610 may include a light source (e.g., a cold-cathode fluorescent lamp) configured to emit white light. In some embodiments, BLU 610 may include blue light-emitting LEDs, a light guide plate, and a quantum dot film that includes quantum dots for converting some blue light to red light and green light.

In the illustrated example, the LCD cell may include a first substrate 630 (e.g., a glass substrate or another transparent dielectric substrate) including a thin-film transistor (TFT) array 632 formed thereon. TFT array 632 may include an array of transistors for controlling the intensity of each pixel (e.g., by controlling the orientations of the liquid crystal molecules in a liquid crystal layer, thereby controlling the rotation angle of the polarization direction of the incident light). The LCD cell may also include a second substrate 640 with a common electrode 644 and a color filter (CF)/black-matrix (BM) array 642 formed thereon. One or more liquid crystal layers 650 may be sandwiched by first substrate 630 and second substrate 640.

In some other implementations, first substrate 630 may include both TFT array 632 and color filters formed on TFT array 632 to form a color filter on array (COA) structure, whereas the top substrate may include a common electrode and a black matrix formed on another glass substrate. The COA structure may enable a simplified process, improved aperture ratio, and reduced production cost. In some implementations, the LCD cell may be a fringe field switching (FFS) mode LCD cell, where the pixel electrodes and the common electrode may both be formed on the bottom substrate, and the top substrate may include a black matrix and an overcoat layer formed thereon.

Light emitted by BLU 610 (e.g., white light or blue light) may be polarized by first polarizer 620 (e.g., a linear polarizer with a polarizing axis in a first direction). The polarized light may pass through an array of apertures between the TFTs in TFT array 632. The polarized light may be modulated by the one or more liquid crystal layers 650 to change the polarization state (e.g., the polarization direction) according to the voltage signal applied to each region of the one or more liquid crystal layers 650. CF/BM array 642 may include red, green, and blue color filters, where each color filter may allow light of one color to pass through. Light passing through each color filter may become a subpixel of a color image pixel that may include three subpixels, and may be filtered by second polarizer 660 such that the change in the polarization state may be converted into a change in the light intensity or brightness. For example, second polarizer 660 may include a linear polarizer with a polarizing axis in a second direction that may be the same as or different from the first direction.

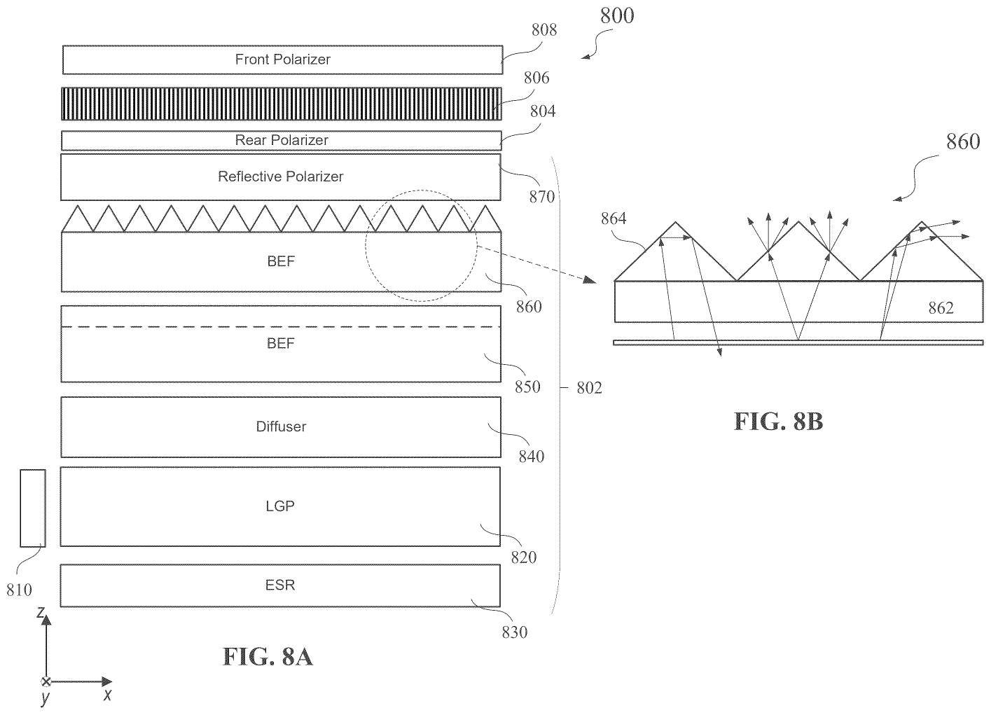

FIG. 7 illustrates an example of a layer stack of an LCD panel 700. LCD panel 700 may be an example of LCD panel 600. In the illustrated example, LCD panel 700 may include a BLU 710, a first polarizer 720, a first substrate 730 including a TFT array and/or black-mask 732 and an array of apertures 734 formed thereon, a common electrode layer 735, a second substrate 740 with a CF/BM array including a black-matrix layer 742 and optionally an array of color filters 744 in black-matrix layer 742, and a second polarizer 750. BLU 710 may be similar to BLU 610 described above. TFT array and/or black-mask 732 may include TFT circuits (e.g., TFTs, gate electrodes, source electrodes, etc.) for controlling liquid crystal molecules filled between first substrate 730 and second substrate 740. Common electrode layer 735 may include a transparent conductive oxide (TCO), such as indium tin oxide (ITO). Color filters 744 may include red, green, and blue color filters. Centers of color filters 744 may align with corresponding centers of apertures 734 on first substrate 730, such that light from BLU 710 and first polarizer 720 may pass through apertures 734 and color filters 744. Second polarizer 750 may include a linear polarizer with a polarizing axis in a direction that is different from or same as the direction of the polarizing axis of first polarizer 720. For example, the direction of the polarizing axis of first polarizer 720 may be orthogonal to the direction of the polarizing axis of second polarizer 750. First polarizer 720 and second polarizer 750 may be used in combination to convert the change in the polarization state (e.g., polarization direction) by the liquid crystal layer to change in the light intensity so as to display images to user's eyes.

As described above with respect to FIG. 6, in some implementations, instead of forming color filters 744 on a separate substrate, color filters 744 may be formed on first substrate 730 (e.g., between TFT array and/or black-mask 732) to form a COA structure. In some implementations, the LCD cell may be an FFS mode LCD cell, where both the pixel electrodes and the common electrode may be formed on first substrate 730 that includes the TFT array and/or black-mask 732. In other implementations, the TFT array, the color filters, the black matrix, and the electrodes may be arranged in other manners on the two substrates that sandwich the liquid crystal material.

Even though not shown in FIG. 7, spacers (e.g., plastic spacers) may be used between TFT array and/or black-mask 732 and common electrode layer 735 to separate TFT array and/or black-mask 732 and common electrode layer 735 so that liquid crystal materials may be filled between TFT array and/or black-mask 732 (or a protective or planarization layer 736) and common electrode layer 735 to modulate incident light. For example, TFT array and/or black-mask 732 may include column spacers formed thereon (e.g., on top of source electrodes), and the CF/BM array (or black-matrix layer 742 or common electrode layer 735) may include photo spacers formed thereon. When first substrate 730 and second substrate 740 are assembled to form an LCD cell, photo spacers may sit on corresponding column spacers to achieve the desired separation between TFT array and/or black-mask 732 and the CF/BM array (or black-matrix layer 742 or common electrode layer 735).

LC panels with higher PPIs (e.g., >600, such as about 1400) may have lower panel transmission. Therefore, it may be desirable to improve the output intensity and efficiency of the BLU to improve the brightness and the overall efficiency of the LCD panel. Many techniques can be utilized to improve the efficiency of BLU, such as prism-based brightness enhance films (BEFs) that can manage the angular output of the light from BLU and focus light towards on-axis viewers of the display, reflective polarizer-based dual brightness enhancement films (DBEFs) that can reflect polarized light not used by the LC panel so that the reflected light can be recycled, and the like.

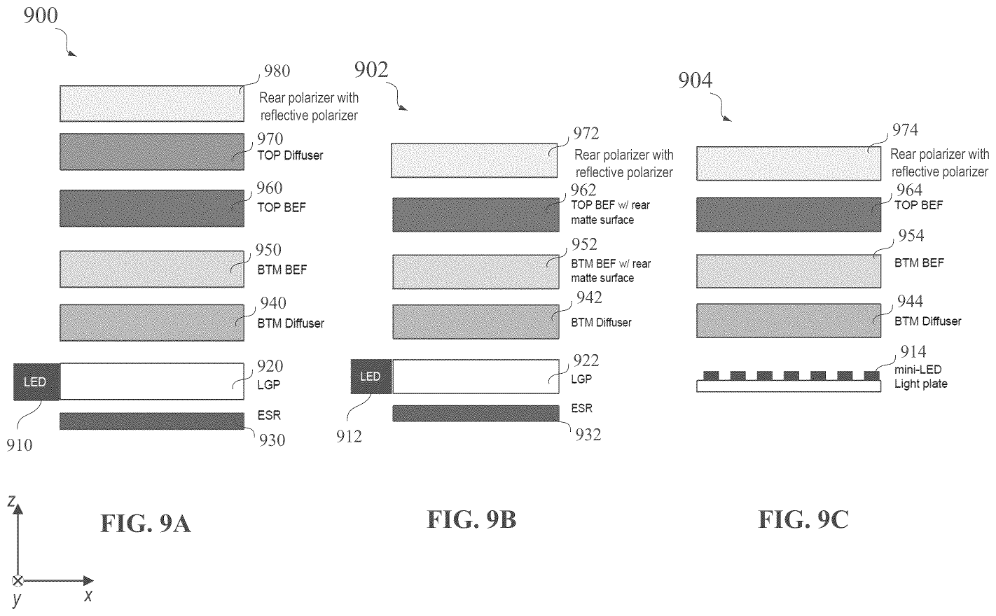

FIG. 8A illustrates an example of a backlight unit (BLU) 802 in an LCD panel 800. LCD panel 800 may include BLU 802 and an LC panel. The LC panel may include a rear polarizer 804, an LC cell 806, and a front polarizer 808. In the illustrated example, BLU 802 may include a light source 810, a light guide plate (LGP) 820, an optional enhanced specular reflector (ESR) film 830, a diffuser 840, a bottom BEF 850, a top BEF 860, and a reflective polarizer 870. In some embodiments, reflective polarizer 870 may be integrated with rear polarizer 804. Light source 810 may include a light source configured to emit white light, such as an array of LEDs. The array of LEDs may include blue-light emitting LEDs and phosphors (e.g., yttrium, aluminum and garnet (YAG) phosphors) that may convert some blue light to green, yellow, and red light to produce white light.

Light emitted by light source 810 may be coupled into LGP 820 and may be guided by LGP 820 (e.g., through total internal reflection) to propagate in approximately the x direction. Portions of the light guided by LGP 820 may be coupled out of LGP 820 towards diffuser 840 by micro-structures, such as, for example, V-shaped blades, printed dots, particulates, diffusion reflectors, and the like, formed on LGP 820. LGP 820 may be flat or may have a wedge shape. ESR film 830 may include a multi-layer optical film (e.g., including dielectric materials) that forms a highly efficient specular reflector, such as with a reflectivity greater than about 95% or higher. ESR film 830 may be used to reflect incident light back towards LGP 820 and LC cell 806.

Light emitted from LGP 820 may be diffused by diffuser 840 to generate a uniform light pattern that has low light intensity variation. Bottom BEF 850 and top BEF 860 may include prismatic structures to focus light towards on-axis viewers of the display. Bottom BEF 850 and top BEF 860 may be used alone to provides up to about 60% increase in on-axis brightness, or may be used in combination (e.g., oriented at about 900 with respect to each other) to provide up to about 120% increase in on-axis brightness. Bottom BEF 850 and top BEF 860 may use refraction and reflection to increase the efficiency of backlighting. For example, bottom BEF 850 and top BEF 860 may refract light within a certain emission cone (e.g., within about 350 with respect to the z direction) toward the viewer, whereas light outside the emission cone may be reflected and at least partially recycled until it exits the film at angles within the emission cone.

FIG. 8B illustrates an example of top BEF 860 in backlight unit 802 of FIG. 8A. As illustrated, top BEF 860 may include a substrate 862 and an array of prisms 864 formed on substrate 862. Substrate 862 may include, for example, polyester or another organic or inorganic material. The array of prisms 864 may include, for example, an acrylic resin. The array of prisms 864 may have prism angles, for example, about 90°, and may have a pitch, for example, about 50 μm. As shown in FIG. 8B, light incident on surfaces of the prisms of top BEF 860 from certain angles may be refracted out of top BEF 860, which may result in a confined emitted cone (e.g., within ±35° with respect to the normal direction) with increased (e.g., by about 58%) luminous intensity. Some light incident on surfaces of the prisms of top BEF 860 at angles greater than the critical angle may be reflected at the surfaces due to total internal reflection, and may be further reflected by other surfaces of the prisms back to LGP 820 and ESR film 830. The light reflected back by top BEF 860 may be recycled, for example, by ESR film 830, which may reflect the incident light back towards top BEF 860. A small portion of the light incident on top BEF 860 may be reflected and then refracted out of top BEF 860 and become stray light.

Reflective polarizer 870 may transmit light of a first polarization state (e.g., a linear polarization state) to the LC panel for light modulation and filtering. Reflective polarizer 870 may reflect (rather than absorbing) light of an orthogonal second polarizations state. The light of the second polarization state reflected by reflective polarizer 870 may be reflected back to reflective polarizer 870 by, for example, ESR film 830, where the reflected light may be at least partially converted to light of the first polarization state and thus may at least partially be transmitted by reflective polarizer 870 to LC cell 806. Therefore, light of the second polarization state may be recycled and eventually transmitted by reflective polarizer 870 towards LC cell 806, thereby improving the efficiency of BLU 802. In some implementations, reflective polarizer 870 may be a polymer-based multilayer film that can be laminated onto rear polarizer 804. For example, reflective polarizer 870 may include polyvinyl alcohol (PVA) sheets that are stretched and then dyed with iodine during the manufacturing process to allow light of only a single polarization direction to be transmitted, and thus may be a linear polarizer. Light of other polarization states may be reflected.

In display devices that may be far away from the user's eyes, such as TVs, laptops, or smartphones, it may be desirable that the display devices have large ranges of view angles, such that the displayed content may be viewable by users from many different angles. But a near-eye display (e.g., a head-mounted display) may include display panels near the user's eyes, and may include viewing optics (also referred to as display optics) that can project images displayed by the display panels such that the images may appear to be further away from the user's eyes. Due to the size and weight limitation of the near-eye display, the viewing optics may have limited apertures and limited light acceptance angles. As such, light emitted from the display panels at large angles may not be collected by the viewing optics and projected on the eyebox of the near-eye display. Therefore, the portion of the light that is emitted from the display panels at large angles may be wasted. To improve the efficiency of near-eye display devices, it may be desirable the light emitted from the backlight unit and thus the LCD panel has narrow angular luminance profiles in both the horizontal and vertical planes, such that more emitted light may be collected by the viewing optics.

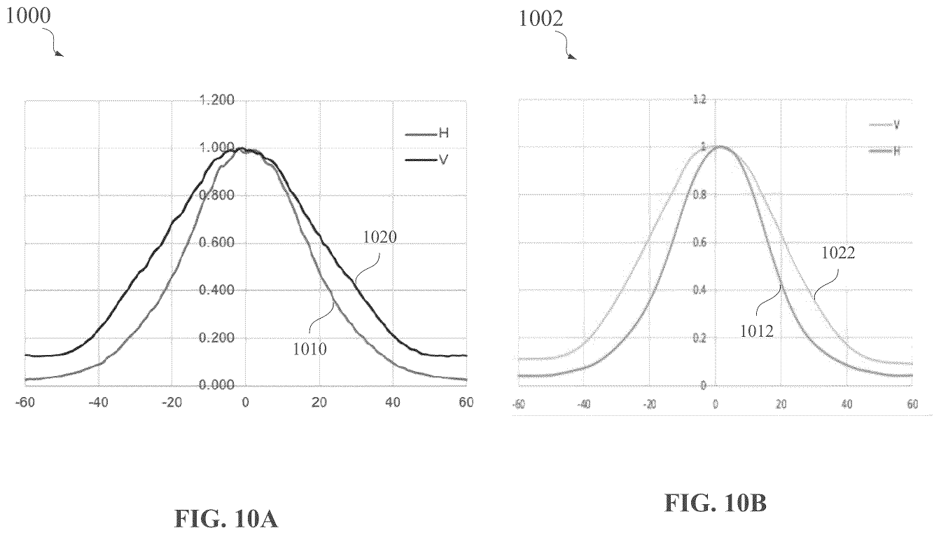

FIG. 9A illustrates an example of a backlight unit 900 of an LCD panel that have a large view angle range. The LCD panel may be for a device that may be positioned away from the user's eyes, such as a TV, a laptop, a tablet, a smartphone, and the like, where viewing optics may not be needed. It is generally desirable that such an LCD panel has a large view angle range, such as greater than about 1200 (±60°) or larger, so that the user may view the displayed content even if the user is not right in front of the LCD panel. In the illustrated example, backlight unit 900 may include a light source 910 (e.g., similar to light source 810), an LGP 920 (e.g., similar to LGP 820), an optional ESR film 930 (e.g., similar to ESR film 830), a bottom diffuser 940 (e.g., similar to diffuser 840), a bottom BEF 950 (e.g., similar to bottom BEF 850), a top BEF 960 (e.g., similar to top BEF 860), a top diffuser 970, and a rear polarizer 980 (e.g., similar to rear polarizer 804) that may be integrated with or include a reflective polarizer (e.g., similar to reflective polarizer 870). Since a wide angular luminance profile is desired, backlight unit 900 may include top diffuser 970 to further diffuse the light used to illuminate the LC panel.

FIG. 9B illustrates an example of an edge-lit backlight unit 902 of an LCD panel of a near-eye display device. Edge-lit backlight unit 902 may be similar to BLU 802 of FIG. 8A. In the illustrated example, backlight unit 902 may include a light source 912 (e.g., similar to light source 810), an LGP 922 (e.g., similar to LGP 820), an optional ESR film 932 (e.g., similar to ESR film 830), a diffuser 942 (e.g., similar to diffuser 840), a bottom BEF 952 (e.g., similar to bottom BEF 850), a top BEF 962 (e.g., similar to top BEF 860), and a rear polarizer 972 (e.g., similar to rear polarizer 804) that may be integrated with or include a reflective polarizer (e.g., similar to reflective polarizer 870). Because a narrower angular luminance profile may be desired, backlight unit 902 may not include the top diffuser 970 of BLU 900.

FIG. 9C illustrates an example of a backlight unit 904 including a two-dimensional array of mini-LEDs in an LCD panel of a near-eye display device. In the illustrated example, backlight unit 904 may include a light source 914 (e.g., including a two-dimensional array of mini- or micro-LEDs formed on a substrate), a diffuser 944 (e.g., similar to diffuser 840), a bottom BEF 954 (e.g., similar to bottom BEF 850), a top BEF 964 (e.g., similar to top BEF 860), and a rear polarizer 974 (e.g., similar to rear polarizer 804) that may be integrated with or include a reflective polarizer (e.g., similar to reflective polarizer 870). Because a narrower angular luminance profile may be desired, backlight unit 904 may not include the top diffuser 970 of BLU 900.

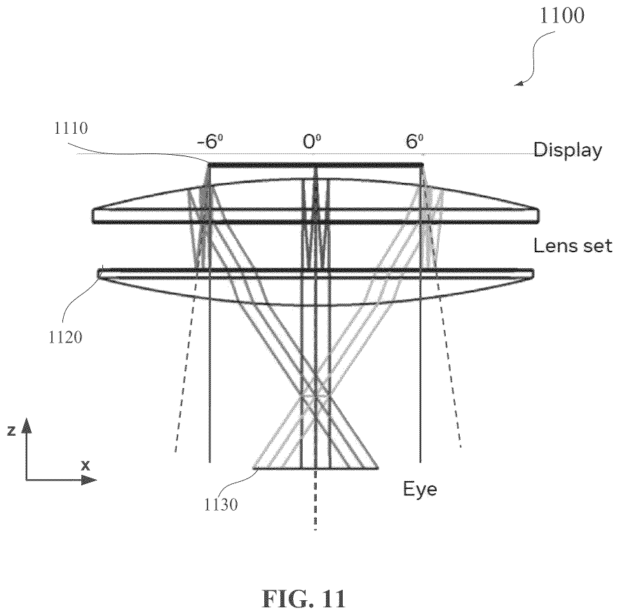

FIG. 10A includes a diagram 1000 illustrating angular luminance profiles of an example of an edge-lit backlight unit (e.g., backlight unit 902 of FIG. 9B) in an LCD panel of a near-eye display device. For example, a curve 1010 in diagram 1000 shows the angular luminance profile of the backlight unit in a horizontal plane (e.g., an x-z plane), whereas a curve 1020 in diagram 1000 shows the angular luminance profile of the backlight unit in a vertical plane (e.g., a y-z plane). In the illustrated example, the full-width-half-maximum (FWHM) angular range of the luminance profile in the horizontal plane may be about 38°, but the FWHM angular range of the luminance profile in the vertical plane may be greater than about 50°.

FIG. 10B includes a diagram 1002 illustrating angular luminance profiles of an example of a backlight unit including a two-dimensional array of mini-LEDs (e.g., backlight unit 904 of FIG. 9C) in an LCD panel of a near-eye display device. For example, a curve 1012 in diagram 1002 shows the angular luminance profile of the backlight unit in a horizontal plane (e.g., an x-z plane), whereas a curve 1022 in diagram 1002 shows the angular luminance profile of the backlight unit in a vertical plane (e.g., a y-z plane). In the illustrated example, the FWHM angular range of the luminance profile in the horizontal plane may be about 33°, but the FWHM angular range of the luminance profile in the vertical plane may be about 50°.

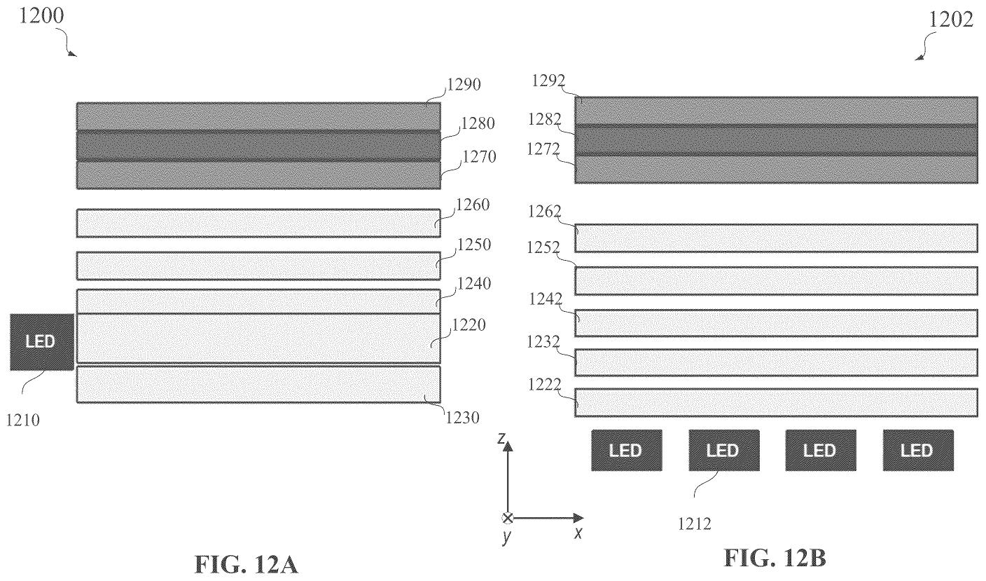

FIG. 11 illustrates an example of a near-eye display 1100 that includes a display panel 1110 (e.g., LCD panel 600, 700, or 800) and display optics 1120 (or viewing optics). Display panel 1110 may generate display images, which may be projected on to a user's eye 1130 by display optics 1120, such as a folded lens (e.g., pancake lens). The chief ray angles (or view angles) seen through display optics 1120 may be different for different regions of display panel 1110. As shown in FIG. 11, for light emitted from any region of display panel 1110, only a portion within a certain angular range may be collected by display optics 1120 and projected on to user's eye 1130. The large FWHM angular range in the vertical plane as shown in FIGS. 10A and 10B may cause a large portion of the light emitted from the LCD panel to fall outside of the acceptance angle range of the viewing optics of the near-eye display, such that the near-eye display may have a low efficiency.

According to certain embodiments disclosed herein, to improve the efficiency of a near-eye display that uses an LCD panel including a BLU and an LC panel, a light collimating film may be used between the BLU and the LC panel (or as a part of the BLU or LC panel) to modify the angular beam profile of the light from the BLU in at least one plane (e.g., a vertical plane). The light collimating film may reflect off-axis light while allowing on-axis or paraxial light to pass through, such that the light beam emitted from the LCD panel may have a narrower beam profile in at least the vertical plane. The angular luminance profile of the light emitted from the BLU in the horizontal plane may be narrowed using, for example, the prism layers. Therefore, the light beam emitted from the BLU and the LCD panel can have narrow angular luminance profiles in both the horizontal plane and the vertical plane, and thus may be more efficiently collected by the viewing optics to deliver to the user's eye.

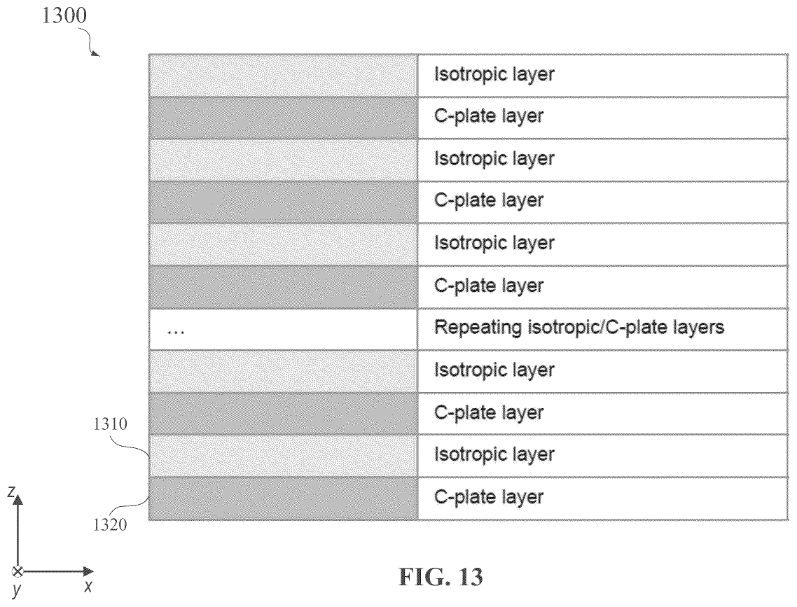

FIG. 12A illustrates an example of an edge-lit backlight unit 1200 including a light collimating film 1280 in an LCD panel of a near-eye display device according to certain embodiments. Backlight unit 1200 may be similar to backlight unit 802 or 902, except that backlight unit 1200 may include light collimating film 1280 between the reflective polarizer and the rear polarizer. In the illustrate example, backlight unit 1200 may include a light source 1210 (e.g., similar to light source 810 or 912), an LGP 1220 (e.g., similar to LGP 820 or 922), an optional ESR film 1230 (e.g., similar to ESR film 830 or 932), a diffuser 1240 (e.g., similar to diffuser 840 or 942), a bottom BEF 1250 (e.g., similar to bottom BEF 850 or 952), and a top BEF 1260 (e.g., similar to top BEF 860 or 962).

In the illustrated example, a reflective polarizer 1270 (e.g., similar to reflective polarizer 870), a light collimating film 1280, and a rear polarizer 1290 (e.g., similar to rear polarizer 804) may be between backlight unit 1200 and an LC panel of the near-eye display, or may be parts of backlight unit 1200 or the LC panel. Reflective polarizer 1270 may allow light of one polarization state to pass through and may reflect light of other polarization states, where the reflected light may be recycled as described above with respect to FIG. 8A. Light collimating film 1280 may allow on-axis light and some paraxial light to pass through, and may at least partially reflect off-axis light, where the reflected light may also be recycled by the ESR film 1230 and components between ESR film 1230 and light collimating film 1280. In some embodiments, reflective polarizer 1270, light collimating film 1280, and rear polarizer 1290 may be integrated into one device on one substrate. In some embodiments, light collimating film 1280 may be between reflective polarizer 1270 and rear polarizer 1290. In some embodiments, reflective polarizer 1270 may be positioned between light collimating film 1280 and rear polarizer 1290.

FIG. 12B illustrates an example of a backlight unit 1202 including a two-dimensional array of mini-LEDs 1212 (or micro-LEDs) and a light collimating film in an LCD panel of a near-eye display device according to certain embodiments. In the illustrated example, backlight unit 1202 may include 2-D array of mini-LEDs 1212, two light mixing films 1222 and 1232, a color conversion layer 1242, a first prism layer 1252 (or another brightness enhancement film), and a second prism layer 1262 (or another brightness enhancement film). The 2-D array of mini-LEDs may include mini-LEDs that may emit light in one color (e.g., blue), and color conversion layer 1242 may convert some of the blue light to green and red light.

In the illustrated example, a reflective polarizer 1272 (e.g., similar to reflective polarizer 870 or 1270), a light collimating film 1282, and a rear polarizer 1292 (e.g., similar to rear polarizer 804 or 1290) may be between backlight unit 1202 and the LC panel of the near-eye display, or may be parts of backlight unit 1202 or the LC panel. Reflective polarizer 1272 may allow light of one polarization state to pass through and may reflect light of other polarization states, and the reflected light may be recycled by the components between 2-D array of mini-LEDs 1212 and reflective polarizer 1272. Light collimating film 1282 may allow on-axis light and some paraxial light to pass through, and may at least partially reflect off-axis light, and the reflected light may also be recycled by the components between 2-D array of mini-LEDs 1212 and light collimating film 1282. In some embodiments, reflective polarizer 1272, light collimating film 1282, and rear polarizer 1292 may be integrated into one device on one substrate. In some embodiments, light collimating film 1282 may be between reflective polarizer 1272 and rear polarizer 1292. In some embodiments, reflective polarizer 1272 may be positioned between light collimating film 1282 and rear polarizer 1292.

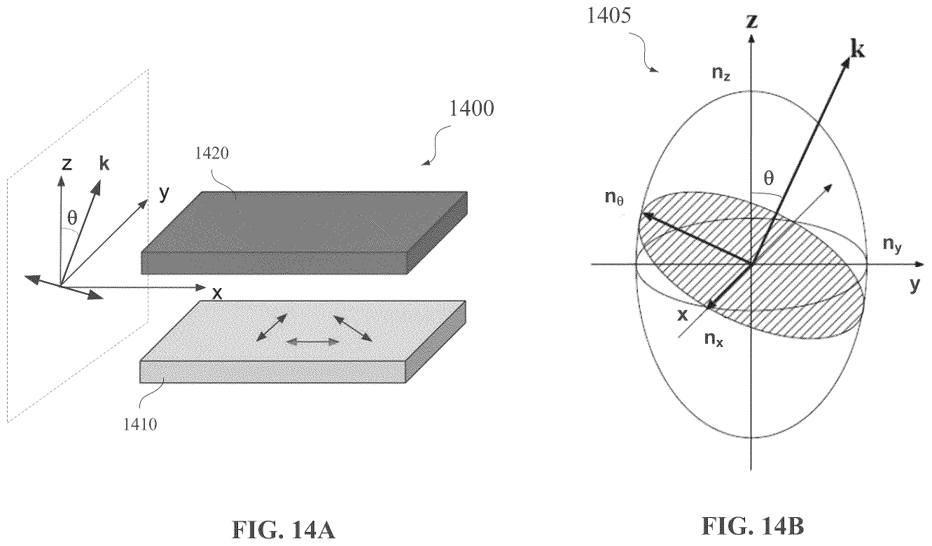

FIG. 13 illustrates an example of a light collimating film 1300 of a backlight unit in an LCD panel of a near-eye display device according to certain embodiments. Light collimating film 1300 may be an example of light collimating film 1280 or 1282 described above. In the illustrated example, light collimating film 1300 may include a plurality of isotropic layers 1310 interleaved with a plurality of C-plate layers 1320. Each isotropic layer 1310 may include an isotropic material having the same refractive index for light having any electric field polarization (or oscillation) direction, that is, nₓ=n_{y}=n_{z}=n₁, where nₓ, n_{y}, and n_{z} are refractive indices for light having electric field polarization direction along the x axis, y axis, and z axis, respectively. Each C-plate layer 1320 may include a uniaxial birefringent material with the optical axis in the z direction, where nₓ=n_{y}=n₁, and n_{z}=n₂≠n₁. In some embodiments, each C-plate layer 1320 may be a −C-plate layer, where n₂<n₁. In some embodiments, each C-plate layer 1320 may be a +C-plate layer, where n₂>n₁.

Since the refractive index of each C-plate layer for light propagating in the surface normal direction (z direction or the optical axis direction) may be n₁, which is equal to the refractive index n₁ of the isotropic material layers, the light propagating in the surface normal direction may experience minimum or no Fresnel reflection at the interface between an isotropic layer and a C-plate layer. The Fresnel reflection at the interface may increase as the incidence angle increases, and may also increase as the difference between the refractive indices of the media at the interface increases. Since the refractive index of the C-plate layer for light propagating in directions that are different from the surface normal direction (the optical axis direction) may be different from the refractive index n₁ of the isotropic layers, and thus the light propagating in directions that are different from the surface normal direction may be at least partially reflected at the interface between an isotropic layer and a C-plate layer due to Fresnel reflection. The larger the difference between the propagation angle and the surface normal direction, the larger the difference between the refractive index of the isotropic layer and the refractive index of the C-plate layer, and thus the higher the reflection. As such, light with larger emission angles may be reflected with higher reflectivity. Therefore, the light passing through the light collimating film may have a narrower angular luminance profile.

In some embodiments, each of the plurality of isotropic layers 1310 and the plurality of C-plate layers 1320 may have an optical thickness about a quarter wavelength of visible light of a certain color. Some layers may have an optical thickness about a quarter of a first wavelength, some other layers may have an optical thickness about a quarter of a second wavelength, and so on. In some embodiments, the thickness of each of the plurality of isotropic layers 1310 and the plurality of C-plate layers 1320 may gradually change to cover all light in the visible spectrum. In some embodiments, isotropic layers and C-plate layers having thicknesses different from quarter wavelengths may be used.

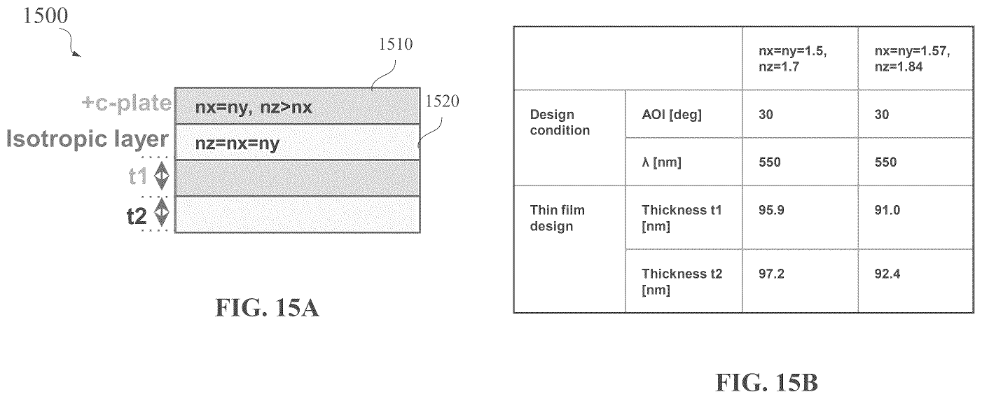

FIG. 14A illustrates an example of a structure 1400 including a reflective polarizer 1410 and a light collimating film 1420 for controlling the angular luminance profile and improving the light efficiency of a backlight unit in an LCD panel of a near-eye display device according to certain embodiments. Reflective polarizer 1410 may be an example of reflective polarizer 870, 1270, or 1272 described above, and may allow light of certain polarization states (e.g., with polarization directions parallel to the y-z plane) to pass through and may reflect light of other polarization states. Light collimating film 1420 may be an example of light collimating film 1280 or 1282, and may be a multi-layer film as described with respect to FIG. 13. As illustrated in FIG. 14A, polarized light passing through reflective polarizer 1410 may have electric field polarization direction parallel to the vertical plane (e.g., the y-z plane), and the light (as indicated by a wave vector k) may propagate at an angle θ with respect to the surface normal (e.g., z) direction.

FIG. 14B illustrates an example of an index ellipsoid 1405 showing the refractive index of a light beam propagating in a uniaxial birefringent material. The illustrated uniaxial birefringent material may have an optical axis in the z direction, where nₓ=n_{y}=n₁, and n_{z}=n₂>n₁. The refractive index no experiences by light propagating in the uniaxial birefringent material at an angle θ with respect to the optical axis (e.g., z) direction may be given by:

$${n}_{θ} = \frac{1}{\sqrt{\frac{{cos}^{2} θ}{{n}_{1}^{2}} + \frac{{sin}^{2} θ}{{n}_{2}^{2}}}} \cdot o 0 ° ,$$

n₀ may be close to n₁. When θ is close to 90°, no may be close to n₂. When θ is between 0° and 90°, no may be between n₁ and n₂. Because the refractive index of the isotropic layer is about n₁, there may be zero or minimum reflection at the interface between an isotropic layer and a C-plate layer when light propagates in the C-plate layer at an angle θ=0° with respect to the z direction. As the angle θ of the light propagation direction increases, the difference between the refractive index no experienced by the light in the C-plate layer and the refractive index n₁ experienced by the light in the isotropic layer may increase, and thus the Fresnel reflection at the interface may increase due to not only the increase in the incidence angle but also the increase in the refractive index difference. As such, light collimating film 1420 may filter the incident light such that the angular luminance profile of the light passing through light collimating film 1420 may be narrowed (having a smaller FWHM angular range). C-plate layers with a larger birefringence may have better collimation effect due to the larger difference between n₁ and n₂.

As illustrated in FIGS. 14A and 14B, light collimating film 1420 may also have similar angular selectivity for light with electric field polarization direction parallel to a horizontal plane (e.g., the x-z plane), if the incident light includes light with electric field polarization direction parallel to the horizontal plane (e.g., without reflective polarizer 1410 in the optical path or with reflective polarizer 1410 after light collimating film 1420).

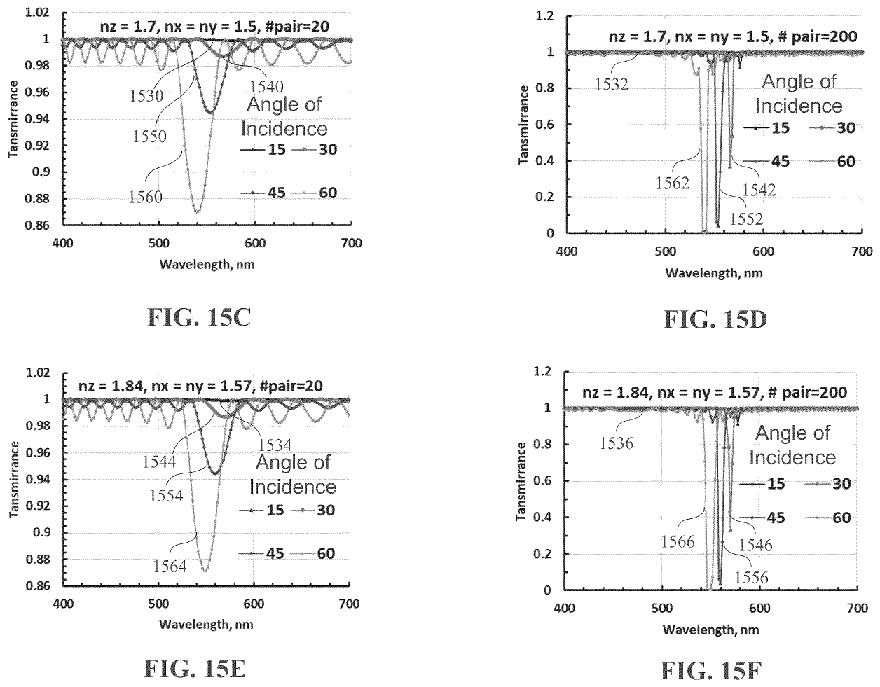

FIG. 15A illustrates an example of a light collimating film 1500 including +C-plate layers according to certain embodiments. In the illustrated example, light collimating film 1500 includes a plurality of +C-plate layers 1510 (with nₓ=n_{y} and n_{z}>nₓ) interleaved with a plurality of isotropic layers 1520 (with nₓ=n_{y}=n_{z}). Each +C-plate layer 1510 may have a thickness t1, and each isotropic layer 1520 may have a thickness t2.

FIG. 15B illustrates examples of parameters of the light collimating film of FIG. 15A according to certain embodiments used for simulation. The examples may be used for collimating light with wavelengths around 550 nm to reduce the FWHM angular range to about 30°. In a first example, nₓ=n_{y}=1.5, n_{z}=1.7, Dn=0.2, thickness t1 is about 95.9 nm, and thickness t2 is about 97.2 nm. In a second example, nₓ=n_{y}=1.57, n_{z}=1.84, Dn=0.27, thickness t1 is about 91.0 nm, and thickness t2 is about 92.4 nm.

FIGS. 15C-15F illustrate simulation results of examples of the light collimating film of FIG. 15A for controlling angular luminance profiles according to certain embodiments. FIG. 15C shows simulated transmittance of the first example of FIG. 15B (Dn=0.2) as a function of the wavelength of the incident light with different angles of incidence, where the light collimating film includes 20 pairs of +C-plate layer 1510 and isotropic layer 1520. In FIG. 15C, curves 1530, 1540, 1550, and 1560 show simulated transmittance for incident light at incident angles of 15°, 30°, 45°, and 60°, respectively. FIG. 15C shows that the transmittance of the light collimating film at around the target wavelength (e.g., 550 nm) may decrease quickly with the increase of the angle of incidence.

FIG. 15D shows simulated transmittance of the first example of FIG. 15B as a function of the wavelength of the incident light with different angles of incidence, where the light collimating film includes 200 pairs of +C-plate layer 1510 and isotropic layer 1520. In FIG. 15D, curves 1532, 1542, 1552, and 1562 show simulated transmittance for incident light at incident angles of 15°, 30°, 45°, and 60°, respectively. FIG. 15D shows that the transmittance of the light collimating film at around the target wavelength (e.g., 550 nm) may decrease quickly with the increase of the angle of incidence and the increase of the number of layers (compared with results in FIG. 15C).

FIG. 15E shows simulated transmittance of the second example of FIG. 15B (Dn=0.27) as a function of the wavelength of the incident light with different angles of incidence, where the light collimating film includes 20 pairs of +C-plate layer 1510 and isotropic layer 1520. In FIG. 15E, curves 1534, 1544, 1554, and 1564 show simulated transmittance for incident light at incident angles of 15°, 30°, 45°, and 60°, respectively. FIG. 15E shows that the transmittance of the light collimating film at around the target wavelength (e.g., 550 nm) may decrease quickly with the increase of the angle of incidence.

FIG. 15F shows simulated transmittance of the second example of FIG. 15B as a function of the wavelength of the incident light with different angles of incidence, where the light collimating film includes 200 pairs of +C-plate layer 1510 and isotropic layer 1520. In FIG. 15F, curves 1536, 1546, 1556, and 1566 show simulated transmittance for incident light at incident angles of 15°, 30°, 45°, and 60°, respectively. FIG. 15F shows that the transmittance of the light collimating film at around the target wavelength (e.g., 550 nm) may decrease quickly with the increase of the angle of incidence and the increase of the number of layers (compared with results in FIG. 15E). FIGS. 15C-15F also show that increasing the difference between the refractive indices of the +C-plate layer and isotropic layer may also increase the reflectivity of the light collimating film for off-axis light.

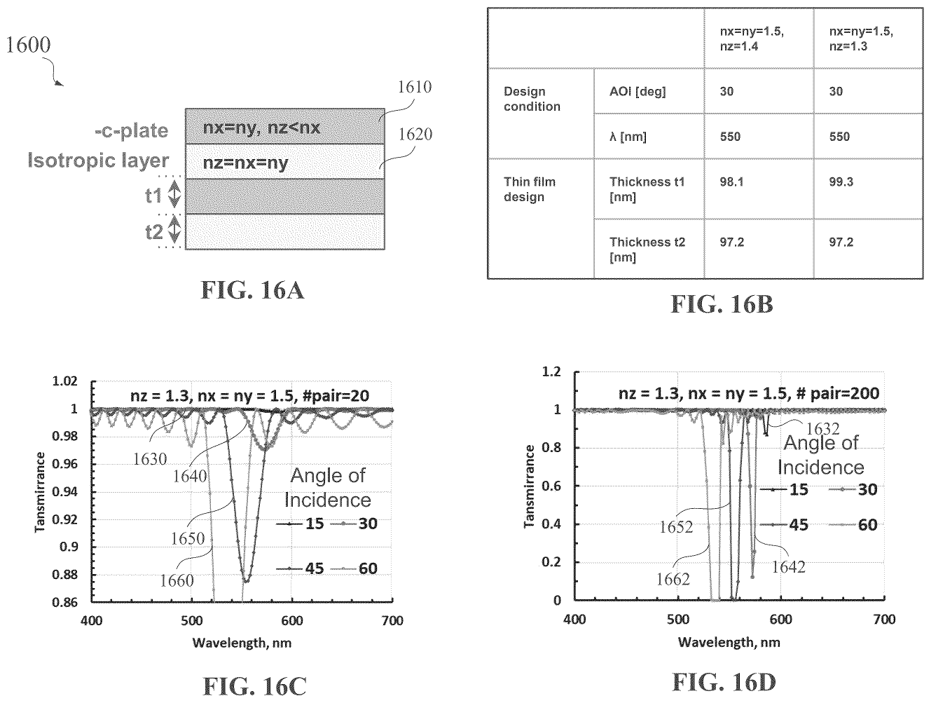

FIG. 16A illustrates an example of a light collimating film 1600 including −C-plate layers according to certain embodiments. In the illustrated example, light collimating film 1600 includes a plurality of −C-plate layers 1610 (with nₓ=n_{y} and n_{z}<nₓ) interleaved with a plurality of isotropic layers 1620 (with nₓ=n_{y}=n_{z}). Each −C-plate layer 1610 may have a thickness t1, and each isotropic layer 1620 may have a thickness t2.

FIG. 16B illustrates examples of parameters of the light collimating film of FIG. 16A according to certain embodiments for simulation. The examples may be used for collimating light with wavelengths around 550 nm to reduce the FWHM angular range to about 30°. In a first example, nₓ=n_{y}=1.5, n_{z}=1.4, Dn=0.1, thickness t1 is about 98.1 nm, and thickness t2 is about 97.2 nm. In a second example, nₓ=n_{y}=1.5, n_{z}=1.3, Dn=0.2, thickness t1 is about 99.3 nm, and thickness t2 is about 97.2 nm.

FIGS. 16C and 16D illustrate simulation results of examples of the light collimating film of FIG. 16A for controlling angular luminance profiles according to certain embodiments. FIG. 16C shows simulated transmittance of the second example of FIG. 16B (Dn=0.2) as a function of the wavelength of the incident light with different angles of incidence, where the light collimating film includes 20 pairs of −C-plate layer 1610 and isotropic layer 1620. In FIG. 16C, curves 1630, 1640, 1650, and 1660 show simulated transmittance for incident light at incident angles of 15°, 30°, 45°, and 60°, respectively. FIG. 16C shows that the transmittance of the light collimating film at around the target wavelength (e.g., 550 nm) may decrease quickly with the increase of the angle of incidence.

FIG. 16D shows simulated transmittance of the second example of FIG. 16B as a function of the wavelength of the incident light with different angles of incidence, where the light collimating film includes 200 pairs of −C-plate layer 1610 and isotropic layer 1620. In FIG. 16D, curves 1632, 1642, 1652, and 1662 show simulated transmittance for incident light at incident angles of 15°, 30°, 45°, and 60°, respectively. FIG. 16D shows that the transmittance of the light collimating film at around the target wavelength (e.g., 550 nm) may decrease quickly with the increase of the angle of incidence and the increase of the number of layers (compared with results in FIG. 16C). As described above, increasing the difference between the refractive indices of the −C-plate layer 1610 and isotropic layer 1620 may also increase the reflectivity of the light collimating film for off-axis light.

Results shown in FIGS. 15C, 15D, 16C, and 16D also indicate that, with the same difference Dn (e.g., Dn=0.2) between the refractive indices of the C-plate layer and isotropic layer, a light collimating film using −C-plate layers may have a wider reflection spectra band and higher reflectivity for off-axis light.

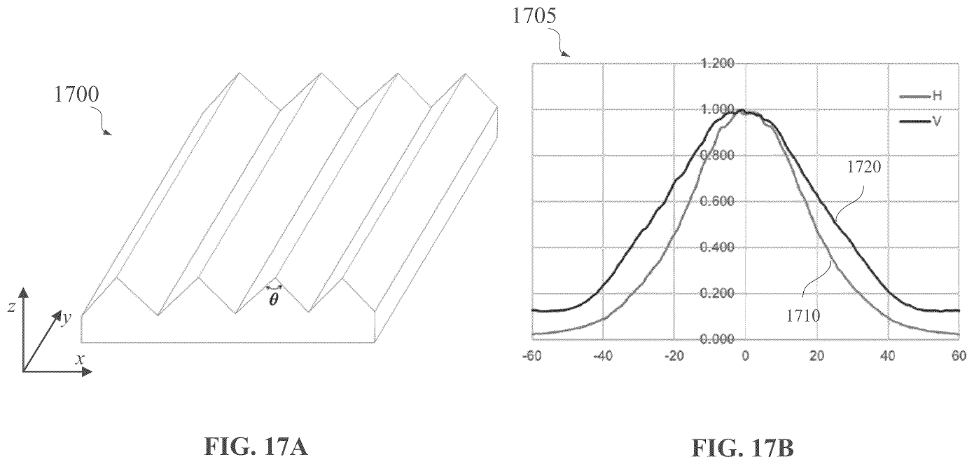

FIG. 17A illustrates an example of a prism layer 1700 for brightness enhancement in a backlight unit where the apex angle of the prisms may be tuned to tune the angular luminance profile of the backlight unit. Prism layer 1700 may be an example of the prism layers (e.g., the top or bottom BEF layers) described above, such as top BEF 860, 962, or 964. As shown in and described above with respect to, for example, FIG. 8B, with different apex angles of the prisms in the BEF layer, different angular ranges of the incident light may be allowed to propagate in the z direction towards the LC cell (e.g., LC cell 806), while light in other angular ranges may be reflected and may not reach the LC cell. Therefore, the angular luminance profile of the backlight unit in, for example, the horizontal plane may be tuned by tuning the apex angle of the prisms of the prism layer.

FIG. 17B includes a diagram 1705 illustrating examples of angular luminance profiles of an example of a backlight unit where the angular luminance profile in the horizontal direction may be reduced by tuning the apex angle of the prisms of prism layer 1700. In the illustrated example, by tuning the apex angle of the prisms of prism layer 1700, the angular luminance profile of the example of the backlight unit in the horizontal plane (shown by a curve 1710) may be much narrower than the angular luminance profile of the example of the backlight unit in the vertical plane (shown by a curve 1720), which may be narrowed using the light collimating film described above. As such, the angular luminance profiles of the backlight unit in both the horizontal plane and the vertical plane may be reduced. Therefore, the light collection efficiency of the viewing optics and the overall efficiency of the near-eye display may be improved.

Embodiments disclosed herein may be used to implement components of an artificial reality system or may be implemented in conjunction with an artificial reality system. Artificial reality is a form of reality that has been adjusted in some manner before presentation to a user, which may include, for example, a virtual reality, an augmented reality, a mixed reality, a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including an HMD connected to a host computer system, a standalone HMD, a mobile device or computing system, or any other hardware platform capable of providing artificial reality content to one or more viewers.

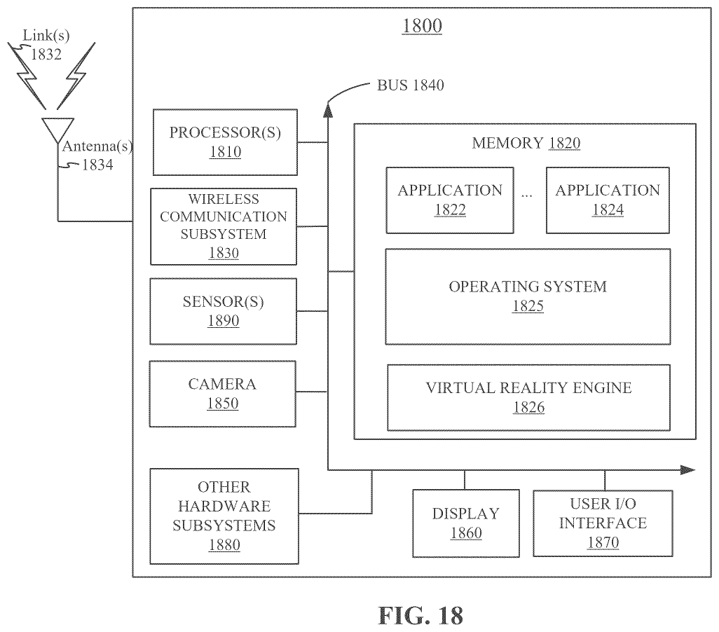

FIG. 18 is a simplified block diagram of an example of an electronic system 1800 of an example near-eye display (e.g., HMD device) for implementing some of the examples disclosed herein. Electronic system 1800 may be used as the electronic system of an HMD device or other near-eye displays described above. In this example, electronic system 1800 may include one or more processor(s) 1810 and a memory 1820. Processor(s) 1810 may be configured to execute instructions for performing operations at a number of components, and can be, for example, a general-purpose processor or microprocessor suitable for implementation within a portable electronic device. Processor(s) 1810 may be communicatively coupled with a plurality of components within electronic system 1800. To realize this communicative coupling, processor(s) 1810 may communicate with the other illustrated components across a bus 1840. Bus 1840 may be any subsystem adapted to transfer data within electronic system 1800. Bus 1840 may include a plurality of computer buses and additional circuitry to transfer data.

Memory 1820 may be coupled to processor(s) 1810. In some embodiments, memory 1820 may offer both short-term and long-term storage and may be divided into several units. Memory 1820 may be volatile, such as static random access memory (SRAM) and/or dynamic random access memory (DRAM) and/or non-volatile, such as read-only memory (ROM), flash memory, and the like. Furthermore, memory 1820 may include removable storage devices, such as secure digital (SD) cards. Memory 1820 may provide storage of computer-readable instructions, data structures, program code, and other data for electronic system 1800. In some embodiments, memory 1820 may be distributed into different hardware subsystems. A set of instructions and/or code might be stored on memory 1820. The instructions might take the form of executable code that may be executable by electronic system 1800, and/or might take the form of source and/or installable code, which, upon compilation and/or installation on electronic system 1800 (e.g., using any of a variety of generally available compilers, installation programs, compression/decompression utilities, etc.), may take the form of executable code.

In some embodiments, memory 1820 may store a plurality of applications 1822 through 1824, which may include any number of applications. Examples of applications may include gaming applications, conferencing applications, video playback applications, or other suitable applications. The applications may include a depth sensing function or eye tracking function. Applications 1822-1824 may include particular instructions to be executed by processor(s) 1810. In some embodiments, certain applications or parts of applications 1822-1824 may be executable by other hardware subsystems 1880. In certain embodiments, memory 1820 may additionally include secure memory, which may include additional security controls to prevent copying or other unauthorized access to secure information.

In some embodiments, memory 1820 may include an operating system 1825 loaded therein. Operating system 1825 may be operable to initiate the execution of the instructions provided by applications 1822-1824 and/or manage other hardware subsystems 1880 as well as interfaces with a wireless communication subsystem 1830 which may include one or more wireless transceivers. Operating system 1825 may be adapted to perform other operations across the components of electronic system 1800 including threading, resource management, data storage control and other similar functionality.

Wireless communication subsystem 1830 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 1800 may include one or more antennas 1834 for wireless communication as part of wireless communication subsystem 1830 or as a separate component coupled to any portion of the system. Depending on desired functionality, wireless communication subsystem 1830 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 1830 may permit data to be exchanged with a network, other computer systems, and/or any other devices described herein. Wireless communication subsystem 1830 may include a means for transmitting or receiving data, such as identifiers of HMD devices, position data, a geographic map, a heat map, photos, or videos, using antenna(s) 1834 and wireless link(s) 1832.

Embodiments of electronic system 1800 may also include one or more sensors 1890. Sensor(s) 1890 may include, for example, an image sensor, an accelerometer, a pressure sensor, a temperature sensor, a proximity sensor, a magnetometer, a gyroscope, an inertial sensor (e.g., a subsystem that combines an accelerometer and a gyroscope), an ambient light sensor, or any other similar devices or subsystems operable to provide sensory output and/or receive sensory input, such as a depth sensor or a position sensor. For example, in some implementations, sensor(s) 1890 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 1800 may include a display 1860. Display 1860 may be a near-eye display, and may graphically present information, such as images, videos, and various instructions, from electronic system 1800 to a user. Such information may be derived from one or more applications 1822-1824, virtual reality engine 1826, one or more other hardware subsystems 1880, a combination thereof, or any other suitable means for resolving graphical content for the user (e.g., by operating system 1825). Display 1860 may use liquid crystal display (LCD) technology, light-emitting diode (LED) technology (including, for example, OLED, ILED, μLED, AMOLED, TOLED, etc.), light emitting polymer display (LPD) technology, or some other display technology.

Electronic system 1800 may include a user input/output interface 1870. User input/output interface 1870 may allow a user to send action requests to electronic system 1800. An action request may be a request to perform a particular action. For example, an action request may be to start or end an application or to perform a particular action within the application. User input/output interface 1870 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 1800. In some embodiments, user input/output interface 1870 may provide haptic feedback to the user in accordance with instructions received from electronic system 1800. For example, the haptic feedback may be provided when an action request is received or has been performed.

Electronic system 1800 may include a camera 1850 that may be used to take photos or videos of a user, for example, for tracking the user's eye position. Camera 1850 may also be used to take photos or videos of the environment, for example, for VR, AR, or MR applications. Camera 1850 may include, for example, a complementary metal-oxide-semiconductor (CMOS) image sensor with a few millions or tens of millions of pixels. In some implementations, camera 1850 may include two or more cameras that may be used to capture 3-D images.

In some embodiments, electronic system 1800 may include a plurality of other hardware subsystems 1880. Each of other hardware subsystems 1880 may be a physical subsystem within electronic system 1800. While each of other hardware subsystems 1880 may be permanently configured as a structure, some of other hardware subsystems 1880 may be temporarily configured to perform specific functions or temporarily activated. Examples of other hardware subsystems 1880 may include, for example, an audio output and/or input interface (e.g., a microphone or speaker), a near field communication (NFC) device, a rechargeable battery, a battery management system, a wired/wireless battery charging system, etc. In some embodiments, one or more functions of other hardware subsystems 1880 may be implemented in software.

In some embodiments, memory 1820 of electronic system 1800 may also store a virtual reality engine 1826. Virtual reality engine 1826 may execute applications within electronic system 1800 and receive position information, acceleration information, velocity information, predicted future positions, or some combination thereof of the HMD device from the various sensors. In some embodiments, the information received by virtual reality engine 1826 may be used for producing a signal (e.g., display instructions) to display 1860. For example, if the received information indicates that the user has looked to the left, virtual reality engine 1826 may generate content for the HMD device that mirrors the user's movement in a virtual environment. Additionally, virtual reality engine 1826 may perform an action within an application in response to an action request received from user input/output interface 1870 and provide feedback to the user. The provided feedback may be visual, audible, or haptic feedback. In some implementations, processor(s) 1810 may include one or more GPUs that may execute virtual reality engine 1826.

In various implementations, the above-described hardware and subsystems may be implemented on a single device or on multiple devices that can communicate with one another using wired or wireless connections. For example, in some implementations, some components or subsystems, such as GPUs, virtual reality engine 1826, and applications (e.g., tracking application), may be implemented on a console separate from the head-mounted display device. In some implementations, one console may be connected to or support more than one HMD.

In alternative configurations, different and/or additional components may be included in electronic system 1800. Similarly, functionality of one or more of the components can be distributed among the components in a manner different from the manner described above. For example, in some embodiments, electronic system 1800 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” may refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms “and” and “or,” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or any combination of A, B, and/or C, such as AB, AC, BC, AA, ABC, AAB, AABBCCC, or the like.

In this description, the recitation “based on” means “based at least in part on.” Therefore, if X is based on Y, then X may be a function of at least a part of Y and any number of other factors. If an action X is “based on” Y, then the action X may be based at least in part on at least a part of Y.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A liquid crystal display comprising:
a liquid crystal (LC) panel;
a backlight unit; and
a light collimating film that is a part of the LC panel, a part of the backlight unit, or between the LC panel and the backlight unit, wherein the light collimating film is configured to transmit on-axis light and at least partially reflect off-axis light.

2. The liquid crystal display of claim 1, wherein the light collimating film includes a plurality of isotropic layers interleaved with a plurality of C-plate layers.

3. The liquid crystal display of claim 2, wherein each of the plurality of C-plate layers includes a uniaxial birefringent material with an optical axis in a surface normal direction of the LC panel.

4. The liquid crystal display of claim 2, wherein an optical thickness of a layer of the plurality of isotropic layers and the plurality of C-plate layers is equal to a quarter of a wavelength of visible light.

5. The liquid crystal display of claim 2, wherein:
an optical thickness of a first layer of the plurality of isotropic layers and the plurality of C-plate layers is equal to a quarter of a first wavelength of visible light; and
an optical thickness of a second layer of the plurality of isotropic layers and the plurality of C-plate layers is equal to a quarter of a second wavelength of visible light.

6. The liquid crystal display of claim 2, wherein optical thicknesses of the plurality of isotropic layers and the plurality of C-plate layers vary gradually.

7. The liquid crystal display of claim 2, wherein the C-plate layers include +C-plate layers, −C-plate layers, or a combination thereof.

8. The liquid crystal display of claim 1, wherein the light collimating film includes more than 100 layers.

9. The liquid crystal display of claim 1, wherein the light collimating film is between a rear polarizer of the LC panel and a reflective polarizer.

10. The liquid crystal display of claim 9, wherein the reflective polarizer is configured to transmit light in a first polarization state and reflect light in an orthogonal polarization state.

11. The liquid crystal display of claim 9, wherein the reflective polarizer is configured to transmit light with polarization directions parallel to a vertical plane.

12. The liquid crystal display of claim 1, wherein the light collimating film is between a reflective polarizer and the backlight unit.

13. The liquid crystal display of claim 1, wherein the light collimating film is integrated onto a same substrate with a rear polarizer of the LC panel, a reflective polarizer, or both the rear polarizer and the reflective polarizer.

14. The liquid crystal display of claim 1, wherein the backlight unit includes an edge-lit backlight unit or a two-dimensional array of mini- or micro-LEDs.

15. The liquid crystal display of claim 1, wherein:
the backlight unit includes a prism layer including a one-dimensional array of prisms arranged along a horizontal direction; and
apex angles of the prisms are selected to reduce a full-width-half-maximum (FWHM) angular range of a luminance profile of the backlight unit in a horizontal plane.

16. A near-eye display comprising:
a backlight unit;
a liquid crystal (LC) panel;
a light collimating film that is a part of the LC panel, a part of the backlight unit, or between the LC panel and the backlight unit, wherein the light collimating film is configured to transmit on-axis light and at least partially reflect off-axis light; and
viewing optics configured to project images displayed by the LC panel to a user's eye.

17. The near-eye display of claim 16, wherein the light collimating film includes a plurality of isotropic layers interleaved with a plurality of C-plate layers.

18. The near-eye display of claim 17, wherein an optical thickness of a layer of the plurality of isotropic layers and the plurality of C-plate layers is equal to a quarter of a wavelength of visible light.

19. The near-eye display of claim 17, wherein:
an optical thickness of a first layer of the plurality of isotropic layers and the plurality of C-plate layers is equal to a quarter of a first wavelength of visible light; and
an optical thickness of a second layer of the plurality of isotropic layers and the plurality of C-plate layers is equal to a quarter of a second wavelength of visible light.

20. The near-eye display of claim 17, wherein optical thicknesses of the plurality of isotropic layers and the plurality of C-plate layers vary gradually.
